(19) United States
(12) Patent Application Publication
(10) Pub. No.: US 2025/0164342 A1
(43) Pub. Date: May 22, 2025

(54) Pipe Wear Detection Apparatus

(71) Applicant: Douglas R. Termeer, Carman (CA)

(72) Inventor: Douglas R. Termeer, Carman (CA)

(21) Appl. No.: 18/932,734

(22) Filed: Oct. 31, 2024

Related U.S. Application Data
(60) Provisional application No. 63/600,304, filed on Nov. 17, 2023.

(51) Int. Cl. G01M 3/28; B65G 53/04

(52) U.S. Cl. CPC G01M 3/2815; B65G 53/04; B65G 2201/04; B65G 2203/0275; B65G 2203/042; B65G 2207/48

(57) ABSTRACT

A pipe wear detection apparatus is used for detecting wear in a pipe. The apparatus includes a jacket member arranged to be mounted externally about a section of the pipe so as to define an enclosed space between the jacket member and the pipe. An indicator operatively connected to the jacket member detects and indicates a change in pressure within the enclosed space. In one embodiment, the jacket member is a resilient sleeve that indicates a leak by inflation or expansion of the sleeve. In other instances, the indicator is an electronic pressure sensor that determines a leak when the measured pressure exceeds a threshold and indicates the leak by automatically activating a visual or audible alarm or by shutting down the associated pneumatic conveying system. The leak can then be repaired before considerable product is lost or before more damage occurs.

### This application claims the benefit under 35 U.S.C.119(e) of U.S. provisional application Ser. No. 63/600,304, filed Nov. 17, 2023.

### FIELD OF THE INVENTION

The present invention relates to a wear detection apparatus for detecting wear on a pipe, for example a pneumatic conveyance pipe for pneumatically conveying particulate material through the pipe.

### BACKGROUND

Pneumatic conveying systems are a simple and effective way of transporting powders, bulk solids and grains. Pneumatic conveying systems may rely on a pressurized flow of air to push particulate material through a network of pipes or tubes between two locations, or alternatively rely on suction or vacuum pressure to pull particulate material between two locations. Using standard tubing or piping components allows the user to have a flexible system that is easy to adapt or repair and economical to set up. With the system being sealed it also allows the user to transport dusty or sensitive products safely.

The largest struggle users have with pneumatic conveying systems is that the product flowing through the conveying line causes the tubing system to wear. When the elbows or piping components wear completely through the material is then dispersed through the hole; this can lead to a number of serious concerns.

If the product is explosive, there are safety concerns with explosive dust being dispersed throughout the facility. Dusty air also makes for an unsafe work environment for employees. If the wear is not caught immediately the user can have a large amount of product that is spoiled and can lead to large losses of product. It can also be expensive to clean up the mess that has been created.

### SUMMARY OF THE INVENTION

According to one aspect of the invention there is provided a pipe wear detection apparatus for detecting wear in a pipe, the apparatus comprising:
a jacket member arranged to be mounted externally about at least a pipe section of the pipe so as to define an enclosed space between the jacket member and the pipe; and
an indicator operatively connected to the jacket member so as to be arranged to indicate a change in pressure within the enclosed space.

The jacket member may be arranged to fully surround the pipe along a length of the pipe between longitudinally opposed ends of the jacket member, in which the ends of the jacket member are arranged to be sealed against the pipe about a full circumference of the pipe.

The apparatus may include two annular clamps arranged to be secured about the opposing ends of the jacket member, in which each annular clamp is arranged to be circumferential constricted to seal the jacket member against the pipe about the full circumference of the pipe.

The enclosed space between the jacket member and the pipe may be annular in shape.

The jacket member may include a resilient portion which is formed of resilient material and which is arranged to expand in response to an increase in pressure within the enclosed space such that the expansion is externally visible, in which the resilient portion at least partly defines the indicator. In some instances, an entirety of the jacket member is formed of said resilient material so as to define the resilient portion.

The indicator may further comprise (i) a pair of mounted elements mounted on the resilient portion such that the mounted elements are movable apart from one another responsive to expansion of the resilient portion, and (ii) an electrical sensor operatively connected to the mounted elements so as to be arranged to activate the sensor in response to displacement of the mounted elements away from one another. The electrical sensor may comprise (i) a contact switch mounted between the mounted elements so as to activate the contact switch in response to displacement of the mounted elements away from one another, (ii) a proximity switch mounted between the mounted elements so as to activate the proximity switch in response to displacement of the mounted elements away from one another, and/or (iii) a strain gauge mounted between the mounted elements so as to activate the strain gauge in response to displacement of the mounted elements away from one another.

The indicator may comprise a pressure sensor in communication with the enclosed space so as to be arranged to detect said change in pressure within the enclosed space. Preferably the pressure sensor is mounted externally of the jacket member and communicates with the enclosed space through a port in the jacket member. A controller may be arranged to activate an alarm in response to a measured change in pressure within the enclosed space exceeding a threshold.

The indicator may comprise a controller operatively connected to a pneumatic conveying system arranged to pneumatically convey particulate material through the pipe section, the controller being arranged to cease operation of the pneumatic conveying system in response to a measured change in pressure within the enclosed space.

Preferably the jacket member is mounted externally about the pipe section such that the enclosed spaced is arranged to contain pressure therein, in which the pipe section may form part of a pneumatic conveyance pipe arranged to pneumatically convey particulate therethrough.

According to a second aspect of the present invention there is provided a method of detecting wear in a pipe, the method comprising:
mounting a jacket member externally about at least a pipe section of the pipe so as to define an enclosed space between the jacket member and the pipe;
monitoring a pressure within the enclosed space; and
indicating a leak in the pipe in response to a change in the pressure within the enclosed space.

According to preferred embodiments, the invention is a sensor that will be installed on common wear sections of the conveying tube, typically elbows, and will alert or indicate to the user, or shut down the pneumatic conveying system, as soon as a hole is formed. An air tight sleeve is installed over the elbow or section of tube and attached and sealed on both ends. This sleeve can be expandable or rigid. When a hole is worn through the conveying tube or elbow, the air from the conveying line will inflate or pressurise the sleeve. In one embodiment, a pressure sensor will trip, alerting the user or shutting down the system. There will also be the option that the sleeve will expand, tripping a magnetic proximity switch, or pulling apart a breakaway type sensor. There are other sensors as well that would be able to detect the increase in size of the tube.

Should any product escape the conveying line through the hole, the sleeve will contain the product preventing any messes and ensuring none of the product enters the atmosphere.

Once worn sections of the conveying line are replaced, the sensor can be reinstalled and reused. This eliminates the need for costly elbows that may have sensors built in. This sensor will allow users to use standard conveying line parts that are economical and simple to replace. When a conveying line typically wears, replacing the part is not the difficult or expensive part, the waste and mess clean up is where the cost is; this invention will solve both of those problems.

If using a pressure sensor to monitor pressure within the enclosed spaced between the jacket member and the exterior of the pipe, the system can be readily adapted to monitor if there is (i) an increase in pressure resulting from a leak in a pressurized flow conveying system, or (ii) a decrease in pressure resulting from a leak in a vacuum pressure conveying system. In the instance of a vacuum pressure conveying system, the jacket member is preferably rigid or otherwise configured so that it does not collapse into a hole worn in a vacuum pressure pipe.

### BRIEF DESCRIPTION OF THE DRAWINGS

Some embodiments of the invention will now be described in conjunction with the accompanying drawings in which:

FIG. 1 is a perspective view of the pipe wear detection apparatus shown supported on a pipe section of a pneumatic conveying pipe according to a first embodiment of the present invention;

FIG. 2 is a side view of the pipe wear detection apparatus according to the first embodiment of FIG. 1;

FIG. 3 is a sectional view along the line 3-3 in FIG. 2;

FIG. 4 is a side view of an indicator according to a second embodiment of the pipe wear detection apparatus;

FIG. 5 is a side view of an indicator according to a third embodiment of the pipe wear detection apparatus; and

FIG. 6 is a side view of an indicator according to a fourth embodiment of the pipe wear detection apparatus.

In the drawings like characters of reference indicate corresponding parts in the different figures.

### DETAILED DESCRIPTION

Referring to the accompanying figures there is illustrated a pipe wear detection apparatus generally indicated by reference numeral 10. The apparatus 10 is particularly suited for monitoring wear that results in a hole being worn through the boundary wall of a pneumatic conveyance pipe 12 of the type used for pneumatically conveying particulate material therethrough. In the illustrated embodiments, the pipe 12 comprises a bent pipe section in which an outlet of the pipe is angularly offset from an inlet of the pipe by 90 degrees for example when the bent pipe section is a right-angle pipe section.

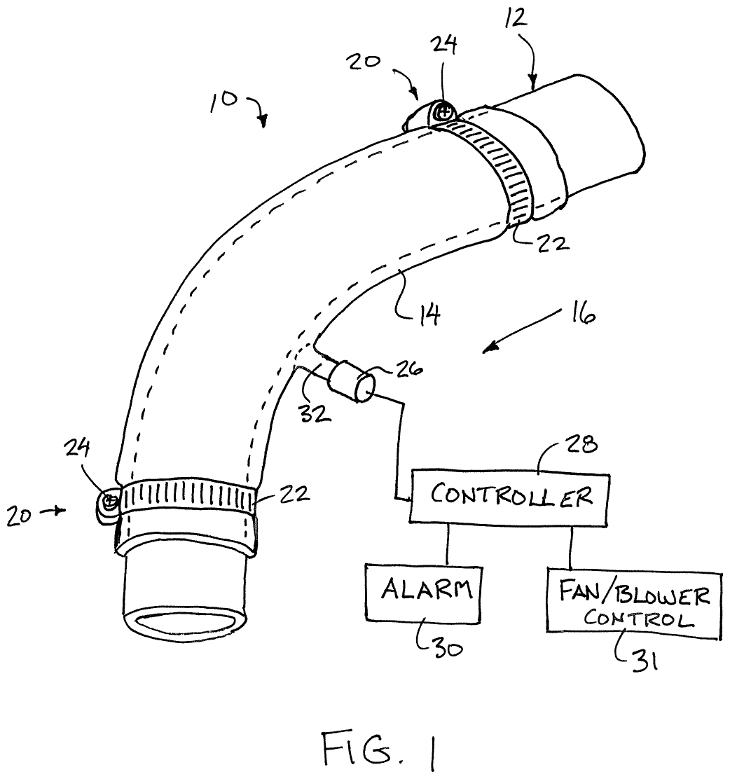

Although various embodiments are illustrated in the accompanying figures, the features in common with the various embodiments will first be described. As best shown in FIG. 1, the apparatus 10 generally includes (i) a jacket member 14 arranged to be mounted externally about the pipe 12 so as to define an enclosed space 18 between the jacket member 14 and the pipe 12 and (ii) an indicator 16 operatively connected to the jacket member so as to be arranged to indicate to a user when there is an increase in pressure within the enclosed space resulting from conveyed material escaping the pipe through a hole worn through the boundary wall of the pipe into the space enclosed by the jacket member. The indication of the leak to the operator can take various forms such as (i) a change in shape or size of the jacket member that is externally visible, (ii) activation of an alarm that is visible or audible to the operator or otherwise communicated to the operator, or (iii) triggering of a change in operation of the pneumatic conveying system associated with the pipe such as deactivating a fan or blower of the pneumatic conveying system.

According to the illustrated embodiments, the jacket 14 comprises an elongated sleeve or tube which is unitary in structure so as to be comprised of a uniform material which is continuous and seamless about the full circumference and about the full length of the tubular shape of the jacket. The jacket member 14 is sized to extend over top of a corresponding pipe section of the pipe when the pipe section is removed from the remainder of the pneumatic conveying system. Accordingly the jacket has a circumference which can extend about the exterior circumference of the pipe section and a length which spans a majority of the length of the pipe section.

The material forming the jacket member 14 is flexible and resilient such that the material is biased to return to an un-stretched state when stretched circumferentially or longitudinally. In some instances, the tube forming the jacket may be sized so that it requires stretching to extend about the circumference of the pipe so that the inner surface of the jacket member is closely fitted about the outer surface of the pipe section. When the jacket member 14 is mounted about the pipe section, an enclosed annular space 18 is typically defined between the exterior of the pipe section 12 and the interior of the jacket member 14 along the full length thereof.

In order to secure the jacket member relative to the pipe section, a clamp assembly 20 is mounted at each of the longitudinally opposed ends of the jacket member. Each clamp assembly 20 comprises an annular band 22 extending circumferentially about the jacket member and a clamping screw 24 operatively connected between opposing ends of the annular band such that rotating the clamping screw constricts the annular band circumferentially about the jacket member surrounding the pipe section. The clamp assembly thus resiliently compresses the jacket member radially and circumferentially between the annular band 22 of the clamp assembly 20 and the exterior circumference of the rigid pipe section 12 about which the jacket member extends. This acts to seal both ends of the jacket member relative to the pipe section such that the annular space 18 between the jacket member 14 and the pipe section 16 is fully enclosed at both ends in the longitudinal direction while being enclosed radially at inner and outer boundaries by the pipe section and the jacket member respectively. In this manner the annular space 18 is a closed space capable of containing fluid under pressure therein.

In the event of a leak in the form of a hole penetrated through the boundary wall of the pipe section that is overlapped by the jacket member, fluid and conveyed material from the interior of the pipe will leak through the hole into the enclosed space 18. As pressure increases within the enclosed space, the increase in pressure causes the resilient material forming the jacket member to be resiliently expanded in a manner that is externally visible due to the expanding circumference of the jacket member.

The resilient nature of the jacket member being externally visible as it expands may alone function as the indicator 16; however, in preferred embodiments an additional electrical sensor 26 is provided in addition to or in place of the expansion of the jacket member as a means of detecting an increase in pressure within the enclosed space 18 and providing further indication of the increase in pressure to an operator of the pneumatic conveying system.

When providing an electrical sensor 26, the sensor is typically configured to generate a suitable signal or detect the absence of a signal when a leak condition results in an increase in pressure within the enclosed space 18. The electrical sensor 26 is typically connected to a controller 28 such as a programmable controller including a memory storing program instructions thereon and a processor for executing the program instructions to perform the functions of the controller. Typically, the controller 28 would detect the change in signal from the electrical sensor 26. In the instance of a sensor that generates a signal representing a measured value, the controller 28 further compares the measured value to a stored threshold amount, and then determines that an increase in pressure in the enclosed space has occurred resulting from a leak in the pipe section when the signal value exceeds the prescribed threshold.

In the event that the controller 28 determines there has been an increase in pressure within the enclosed space 18, the controller 28 can actuate an alarm 30 operatively connected to the controller in which the alarm provides an audible indication or a visual indication to the operator of the pneumatic conveying system as to the presence of a leak in the pipe section. Alternatively, the alarm 30 may generate a suitable alert communication such as an email or text message that is communicated to an electronic device of the operator.

The controller 28 may also be operatively connected to the pneumatic conveying system associated with the pipe section 12 for changing an operating condition of the pneumatic conveying system. The pneumatic conveying system would typically comprise its own computer controller 31 having programming instructions stored in a memory and a processor for executing the program instructions to perform the desired functions of the system. The controller 28 of the wear detection apparatus 10 communicates instructions to the controller 31 of the pneumatic conveying system to change the operating condition by either shutting down operation of a fan or blower of the pneumatic conveying system, or closing of a valve of a branch line of the conveying system locating the pipe section 12 therein while other conveying lines may remain operational.

The combination of the electrical sensor 26, the controller 28, the alarm 30, and the control 31 of the pneumatic conveying system collectively define an indicator for indicating an increase in pressure within the enclosed space 18 in the above examples.

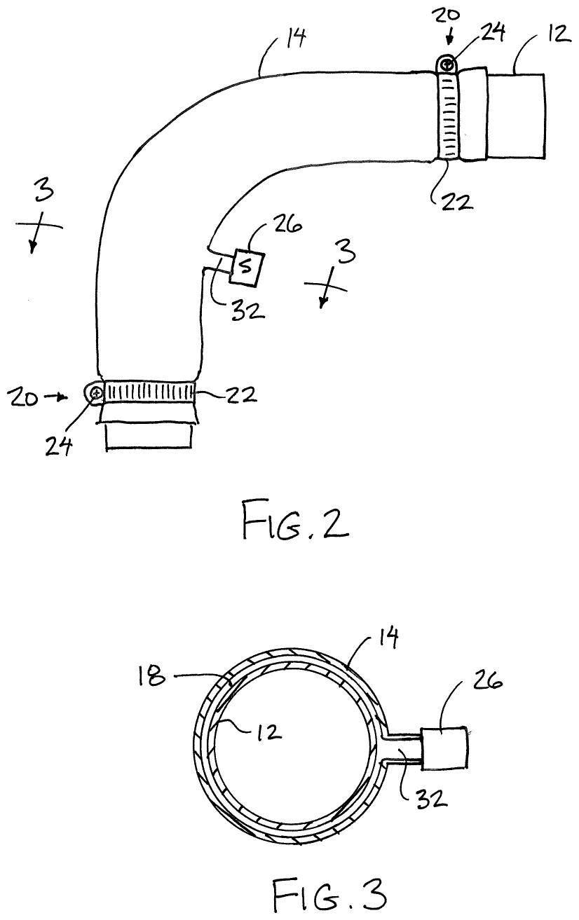

Turning now more particularly to the embodiment of FIGS. 1 through 3, in this instance the electrical sensor 26 comprises a pressure sensor which is mounted externally of the jacket member but which communicates with the enclosed space 18 within the interior of the jacket member through a suitable port 32 communicating through the boundary wall of the jacket member. The pressure sensor is sealed in communication with the port 32 to prevent escape of fluid or pressure from the interior of the jacket member through the port 32 while enabling communication of pressure from the interior of the annular space 18 to the pressure sensor. In the illustrated embodiment, the jacket member may be formed from a section of an inner tube for a tire in which the port 32 is defined by a valve stem of the inner tube. The pressure sensor 26 is arranged to generate an electrical signal defining a magnitude that is representative of the pressure within the enclosed space 18. The signal is communicated to the controller such that the controller can determine a corresponding pressure based on the pressure value represented by the signal from the pressure sensor 26. This pressure value is compared to a threshold value stored on the controller to determine if the measured pressure exceeds the threshold amount so as to determine an increase in pressure corresponding to a leak in the pipe section.

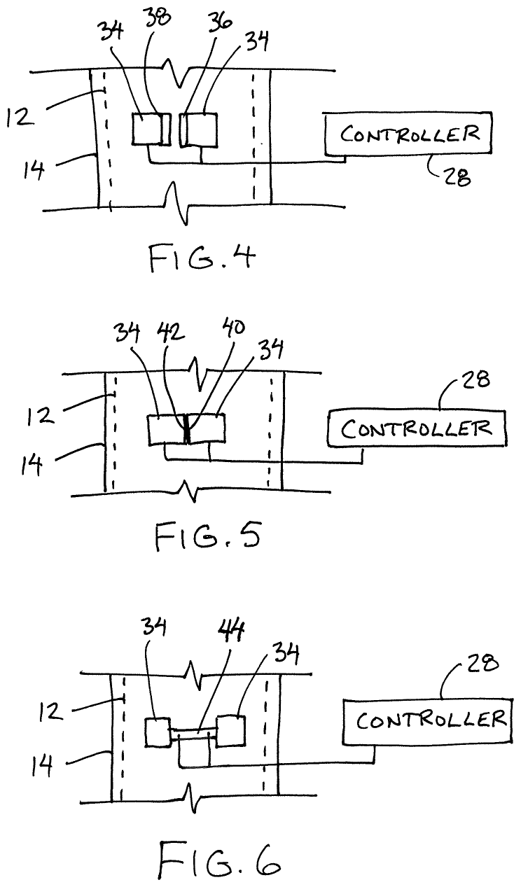

Turning now to FIGS. 4 through 6 relating to additional embodiments, in each instance the electrical sensor 26 is configured for detecting the physical expansion of the resilient material of the jacket member 14 in response to an increase in pressure within the enclosed space 18. In each instance, the overall indicator 16 comprises two mounted elements 34 which are fixedly mounted to the exterior of the jacket member at spaced apart locations which may be spaced apart longitudinally, circumferentially or a combination thereof. In a preferred embodiment each mounted element 34 is secured to the exterior of the jacket member by adhesive or by mechanical fastening for example. The sensor 26 is operatively connected between the elements so as to be arranged to generate a signal or detect the absence of a signal when the mounted elements 34 are displaced away from one another or are under action of a force acting to pull the mounted elements away from one another as a result of the expansion of the jacket member when pressure within the enclosed annular space 18 increases.

In the embodiment of FIG. 4, the electrical sensor 26 comprises a proximity switch including a switch 36 mounted on one of the elements 34 and a magnet 38 mounted on the other element 34 in which the switch 36 opens or closes in response to varying proximity of the magnet 38. The switch 36 communicates with the controller such that the controller can determine when the condition of the switch 36 has changed resulting from the mounted elements 34 being displaced apart from one another in response to an increase in pressure within the enclosed space 18.

In the embodiment of FIG. 5, the sensor 26 comprises a contact switch having a first contact 40 mounted on a first one of the elements 34 and a second contact 42 mounted on a second one of the mounted elements such that the first and second contacts are in conductive contact with one another under normal operation of the pipe section. In the event of expansion of the jacket member due to an increase in pressure within the enclosed space 18, the mounted elements 34 are displaced away from one another which separates the contact between the first and second contacts 40 and 42 to open the contact switch. The contact switch forms part of a circuit of the controller 28 such that the controller can determine when the contact switch is opened resulting from an increase in pressure within the annular space.

In the embodiment of FIG. 6, the electrical sensor 26 comprises a strain gauge 44 operatively connected between the mounted elements 34. The strain gauge comprises a semiconductor material forming part of a circuit of the controller 28 such that the circuit can monitor electrical resistance through the semiconductor material of the strain gauge. When the jacket member is expanded in response to an increase in pressure within the enclosed space 18, the expanding jacket member applies a force to urge the mounted elements 34 apart from one another which in turn applies a stress to the strain gauge which varies the electrical resistance or conductivity thereof in a manner which can be detected by the controller to determine that pressure within the annular space 18 has increased as a result of a leak in the pipe section.

In the event that a leak is detected and the indicator 16 provides indication to the operator of the leak, the pneumatic conveying system can be shut down automatically or manually by the operator to prevent further loss of material through the leak in the pipe section. The operator can then disassemble the pneumatic conveying line by removing the leaking pipe section. The apparatus 10 can be removed from the defective pipe section by releasing the clamp assemblies and removing the jacket member 14 from the pipe section such that the jacket member can be reinstalled using the clamp assemblies onto a new pipe section of similar configuration. Upon mounting of the new pipe section into the pneumatic conveying line to replace the defective pipe section, the apparatus 10 can be reused to continue monitoring the replacement pipe section similarly to the monitoring of the original pipe section.

According to a further embodiment (not shown), when the apparatus 10 is used on a pneumatic conveying system operated at vacuum pressure, the jacket member 14 may be formed of rigid material and the pressure sensor 26 communicates with the enclosed space 18 to monitor pressure within the enclosed space. In the event of a leak in the pipe, the enclosed space 18 will communicate with the vacuum pressure within the interior of the pipe 12 such that pressure within the enclosed space 18 will decrease in a manner that can be measured by the sensor 26. The controller in this instance would receive the pressure signal from the sensor 26 and compare the pressure signal to a threshold to determine that there is a leak if the measured pressure is outside of (below) the threshold range.

Since various modifications can be made in the invention as herein above described, and many apparently widely different embodiments of same made, it is intended that all matter contained in the accompanying specification shall be interpreted as illustrative only and not in a limiting sense.

1. A pipe wear detection apparatus for detecting wear in a pipe, the apparatus comprising:
a jacket member arranged to be mounted externally about at least a pipe section of the pipe so as to define an enclosed space between the jacket member and the pipe; and
an indicator operatively connected to the jacket member so as to be arranged to indicate a change in pressure within the enclosed space.

2. The apparatus according to claim 1 wherein the jacket member is arranged to fully surround the pipe along a length of the pipe between longitudinally opposed ends of the jacket member, the ends of the jacket member being arranged to be sealed against the pipe about a full circumference of the pipe.

3. The apparatus according to claim 2 further comprising two annular clamps arranged to be secured about the opposing ends of the jacket member, each annular clamp being arranged to be circumferential constricted to seal the jacket member against the pipe about the full circumference of the pipe.

4. The apparatus according to claim 1 wherein the enclosed space between the jacket member and the pipe is annular in shape.

5. The apparatus according to claim 1 wherein the jacket member includes a resilient portion which is formed of resilient material and which is arranged to expand in response to an increase in pressure within the enclosed space such that the expansion is externally visible, the resilient portion at least partly defining the indicator.

6. The apparatus according to claim 5 wherein an entirety of the jacket member is formed of said resilient material so as to define the resilient portion.

7. The apparatus according to claim 5 wherein the indicator comprises (i) a pair of mounted elements mounted on the resilient portion such that the mounted elements are movable apart from one another responsive to expansion of the resilient portion, and (ii) an electrical sensor operatively connected to the mounted elements so as to be arranged to activate the sensor in response to displacement of the mounted elements away from one another.

8. The apparatus according to claim 7 wherein the electrical sensor comprises a contact switch mounted between the mounted elements so as to activate the contact switch in response to displacement of the mounted elements away from one another.

9. The apparatus according to claim 7 wherein the electrical sensor comprises a proximity switch mounted between the mounted elements so as to activate the proximity switch in response to displacement of the mounted elements away from one another.

10. The apparatus according to claim 7 wherein the electrical sensor comprises a strain gauge mounted between the mounted elements so as to activate the strain gauge in response to displacement of the mounted elements away from one another.

11. The apparatus according to claim 1 wherein the indicator comprises a pressure sensor in communication with the enclosed space so as to be arranged to detect said change in pressure within the enclosed space.

12. The apparatus according to claim 11 wherein the pressure sensor is mounted externally of the jacket member and communicates with the enclosed space through a port in the jacket member.

13. The apparatus according to claim 1 wherein the indicator comprises a controller arranged to activate an alarm in response to a measured change in pressure within the enclosed space.

14. The apparatus according to claim 1 wherein the indicator comprises a controller operatively connected to a pneumatic conveying system arranged to pneumatically convey particulate material through the pipe section, the controller being arranged to cease operation of the pneumatic conveying system in response to a measured change in pressure within the enclosed space.

15. The apparatus according to claim 1 in combination with the pipe section, wherein the jacket member is mounted externally about the pipe section such that the enclosed spaced is arranged to contain pressure therein.

16. The apparatus according to claim 15 wherein the pipe section forms part of a pneumatic conveyance pipe arranged to pneumatically convey particulate therethrough.

17. A method of detecting wear in a pipe, the method comprising:
mounting a jacket member externally about at least a pipe section of the pipe so as to define an enclosed space between the jacket member and the pipe;
monitoring a pressure within the enclosed space; and
indicating a leak in the pipe in response to a change in the pressure within the enclosed space.
